(19) United States
(12) Patent Application Publication
(10) Pub. No.: US 2019/0046912 A1
(43) Pub. Date: Feb. 14, 2019

(54) SUPPORT CAGE FOR A FILTER ELEMENT, FILTER ELEMENT, AND USE FOR SUCH A FILTER ELEMENT

(71) Applicant: Donaldson Filtration Deutschland GmbH, Haan (DE)

(72) Inventors: Peter Groth, Düsseldorf (DE); Peter Schwarz, Düsseldorf (DE)

(21) Appl. No.: 16/079,747

(22) PCT Filed: Feb. 21, 2017
(86) PCT No.: PCT/EP2017/000244

§ 371 Date: Aug. 24, 2018

(30) Foreign Application Priority Data
Feb. 25, 2016 (DE) 10 2016 002 145.4

(51) Int. Cl. B01D 46/24; B01D 46/00

(52) U.S. Cl. CPC B01D 46/2411; B01D 2265/06; B01D 46/0002

(57) ABSTRACT

The invention relates to a support retainer for filter element with a base body, which extends along a longitudinal axis from an upper end to a lower end and a retainer wall is formed between the upper and the lower end, and wherein the retainer wall is formed perpendicular to the longitudinal axis in a ring-shaped at least in a cross section, and the retainer wall has a plurality of openings and the retainer wall is at least partially manufactured from a plastic, wherein the openings are rhombus-shaped.

The invention relates to a support retainer for a filter element, a filter element and a use of such a filter element.

From U.S. Pat. No. 6,179,131 B1, a method to manufacture a filter element is known. In the exemplary embodiments of U.S. Pat. No. 6,179,131 B1, in particular, by means of the FIGS. 1, 2, 3, and 4, the shape of a support retainer (there “outer cylindrical member 58”) is described for a filter element. The support retainer shown there has a base body, which extends along a longitudinal axis from an upper end to a lower end and which forms a retainer wall between the upper end and the lower end. The retainer well serves to retain and support a filter material (there “fibrous filter material 46”). The support retainer shown there is hollow cylindrical in shape and is therefore ring-shaped in each cross section perpendicular to its longitudinal axis. The retainer wall has a plurality of rectangular openings and is manufactured from a plastic.

Based on this most recent background art, the object of the invention is to increase the stiffness of the support retainer and/or to increase its perfusion surface area.

The task is achieved by means of the object of claim 1. Favourable embodiments are reflected in the subclaims and in the description to follow.

The invention is based on the basic conception of forming the plurality of openings of the retainer wall in a rhombus shape. It has been shown that, in the case of a retainer wall manufactured from plastic, the stiffness of such a retainer wall manufactured from plastic can be increased. Furthermore, an opening profile is created by the rhombus shape, which does not have any right angles. This circumstance can be used in order to avoid the formation of nicks or cracks on the corners of the lateral surfaces abutting the openings. The increased stiffness makes it possible to design the bars between the openings narrower, thereby increasing the perfusion surface of the support retainer.

The support retainer has a base body. This base body extends along an longitudinal axis from an upper end to a lower end. Thereby, the base body forms a retainer wall between the upper end and the lower end. At least in a cross section, especially preferred in the plurality of the cross sections and quite especially preferred in all cross sections perpendicular to the longitudinal axis, the retainer wall is ring-shaped. Being particularly preferred, it is shaped like a circular ring, wherein also elliptical ring shape or a rectangular ring shape are conceivable. In a preferred embodiment, the plurality of ring-shaped cross sections namely have identical geometries and the same size, particularly being preferred if all the ring-shaped cross sections are identical in shape. However, embodiments are conceivable where the cross-sectional size of the support retainer is tapered or widened in the direction of the upper end or in the direction of the lower end. In such embodiments, the geometric shape of the plurality of ring-shaped cross sections, particularly preferred all ring-shaped cross sections, can be identically selected while the size can change.

The retainer wall has a plurality of openings. In a preferred embodiment, the sum of the surfaces corresponding the shape of the openings on the outer surface of the main body (the perfusion surface of the respective opening on the outer surface of the main body) is greater than the sum of the surfaces facing outwards of the bars of the retainer wall remaining between the openings. In a preferred embodiment the sum is of surfaces corresponding to the shape of the openings on the outer surface of the main body are greater than 1.1 times, particularly preferred 1.2 times, particularly preferred more than 1.3 times and particularly preferred more than 1.5 times larger than the sum of the surfaces facing outwards of the bars of the retainer wall remaining between the openings.

The retainer wall is at least partially manufactured from a plastic. Being particularly preferred, the retainer wall is primarily manufactured from a plastic. Being particularly preferred, the retainer wall is totally manufactured from a plastic. In a preferred embodiment, the plastic is a polymer, more preferably, polypropylene. In a preferred embodiment, the plastic is a plastic capable of being injection moulded. In a preferred embodiment, the retainer wall is manufactured by means of injection moulding. To the extent of the invention of embodiments are described in this description, where the retainer walls are entirely made of plastic, this does not rule out that the retainer wall or parts of the retainer wall are provided with a surface coating, for example, a paint or are coated with a film, which is not made of plastic. It is also conceivable that, in the case of a retainer wall completely manufactured out of plastic, a functional component introduced into the retainer wall, such as a wire for example, is not made of plastic. In particular, it is preferred if such a wire is however a single electrical line (cable), which is led through the retainer wall.

The invention proposes to design the openings to be rhombus-shaped. The surface corresponding to the shape of the opening on the outer surface and/or the shape of the opening on the inner surface is rhombus-shaped. Since the retainer wall is formed perpendicular to the longitudinal axis in a ring-shaped at least in a cross section, it is also understood that the surface corresponding to the shape of the opening on the outer surface of the retainer wall settled into a level and/or the shape of the opening on the inner surface of the retainer wall settled into a level is rhombus-shaped. In a preferred embodiment, the rhombus shape is selected in such a way that the obtuse angles lying opposite to each other are between 100° and 160°, more preferably between 110° and 150°, being particularly preferred between 120° and 140°.

According to the invention, a plurality of openings of the retainer wall are rhombus-shaped. This does not rule out that the retainer wall has other openings that are not rhombus-shaped. In this way, in a preferred embodiment, it can be provided that, on the upper end of the retainer wall and/or on the lower end of the retainer wall, openings are provided that are not rhombus-shaped. Openings that are not rhombus-shaped and provided at the end of the retainer wall can be used in order to use the space between two adjacent rhombus-shaped openings for an opening, thereby increasing the perfusion surface of the retainer wall. In a particularly preferred embodiment, the retainer wall has a first group of openings, which are rhombus-shaped, and a second group of openings, which are not rhombus-shaped, the opening geometry of which can however be illustrated as a cross-sectional surface of a rhombus, for example, as half of a rhombus, which has been cut along a line that connects two end points. In a particularly preferred embodiment, the retainer wall only has these two types of openings. In an alternative and also preferred embodiment, the retainer wall only has rhombus-shaped openings. In a preferred embodiment, all rhombus-shaped openings have the same geometry (the same obtuse angles). In a preferred embodiment, the lateral lengths of all rhombus-shaped openings of the retainer wall are equal.

In a preferred embodiment, the extension of a rhombus-shaped opening or a subgroup of the plurality of openings, which are rhombus-shaped, or in a particularly preferred embodiment, the extension of all rhombus-shaped openings provided on the retainer wall is larger in the circumferential directions than in a direction parallel to the longitudinal direction of the base body. In the case of such an embodiment, the retainer wall can become somewhat more elastic in the direction parallel to the longitudinal direction of the base body than in a torsion direction, where the upper end is rotated in another direction around the longitudinal axis toward the lower end. It has been shown that the port retainers are stressed with impact loads along the longitudinal direction of the base body, for example, when a filter element having a support retainer is dropped. With this orientation of the rhombuses described in this embodiment, a flexibility of the support retainer in the longitudinal direction can be generated subject to the simultaneous increase of torsion stiffness, which is, for example, of an advantage if the filter element having a support retainer according to the invention should be screwed out of a housing.

In a preferred embodiment, an opening of the plurality of rhombus-shaped openings is limited by four lateral surfaces, of which two are respectively located opposite. The support retainer according to the invention preferably has an outer surface facing outwards in a radial manner and an inner surface facing inwards in a radial direction. In addition, the support retainer has a wall thickness. As a result, these are limited by four lateral surfaces to form rhombus-shaped openings in the retainer wall, wherein each lateral surface of the outer circumferential surface leads to the inner circumferential surface. It has been recognized that technical effects can be implemented with the orientation of the lateral surfaces limiting the openings, however, a particularly simple manufacturing of the support retainer according to the invention can also be achieved, which, according to the invention, is at least partially made of plastic.

In a preferred embodiment, two of the four lateral surfaces, namely two lateral surfaces, which are arranged opposite, are not orientated parallel to one another. In a preferred embodiment, all lateral surfaces located opposite to one another are not orientated running in parallel to one other. In a preferred embodiment, this is used in order to taper or widen the opening cross section of the outer surface of the support retainer toward the inner surface. A tapering of the opening cross section has the additional positive effect that the retainer wall designed in this manner can be manufactured more simply by means of an injection moulding method, in particular, because the correspondingly designed retainer wall can be stripped more easily from the injection moulding tool.

In a complementary or alternative embodiment, at least two of the four lateral surfaces, namely two lateral surfaces located opposite to one another are designed to be parallel to one another. In a preferred embodiment, all of the opposite lateral surfaces of the four lateral surfaces of an opening are designed to be parallel to the lateral surface lying opposite to them respectively. The lateral surfaces running in parallel to one another can be in levels respectively in a preferred embodiment, which run parallel to a line, which is perpendicular to the longitudinal axis of the base body. The lateral surfaces thereby run into the inner space of the base body in a shaft-like manner. Embodiments are also conceivable, where the lateral surfaces running parallel to each other in levels, which run parallel to a line, which does not intersect the longitudinal axis of the base body, however, in a preferred embodiment, which is at a single level that is perpendicular to the longitudinal axis of the base body. Such opening geometries can be generated using sliders in the case of the preferred use of an injection moulding process, which have a rectangular cross section and are movable in a direction perpendicular to the longitudinal axis of the base body. Such geometries of the openings thereby allow for a simple manufacturing of the rhombus-shaped openings. A slider can be designed in such a way that it is used to manufacture a plurality of openings.

In a preferred embodiment, the rhombus-shaped openings are arranged in such a way that the surface centre points of the surfaces corresponding to the shape of the respective opening on the outer surface of the base body (the surface centre point of the perfusion surfaces on the outer surface) are located on rings, the centre point of which lie on the longitudinal axis of the base body. In a preferred embodiment, the arrangement of the surface centre points on a ring are designed to be offset at a ratio to the arrangement of the surface centre points of the openings of an adjacent ring in such a way that the openings of the one ring engage into the space between the openings of an adjacent ring. By means of this, a particularly dense package of openings on the circumferential surface of the retainer wall is achieved.

In a preferred embodiment, the rhombus-shaped openings have consistent pattern with reference to their distributions across the base body. In a particularly preferred embodiment, the surface centre points are arranged on rings, the centre points of which lie on the longitudinal axis of the base body, wherein the surface centre points of every second ring observed in the longitudinal direction are at the same position observed in the circumferential direction as the surface centre points of this ring. The surface centre points thereby alternate from ring to ring with regard to their arrangement in the circumferential direction. In particular, by means of this, and especially dense package of openings can be achieved on the outer circumferential surface of the retainer wall.

Being particularly preferred, the retainer wall has a closed end ring on the upper end and/or on the lower end, in which there is no opening. This end ring can have a graduation in order to facility setting an end cap onto it in order to facility the connection to an end cap.

In a preferred embodiment, bars are formed between the rhombus-shaped openings, which run around the longitudinal axis of the base body in a helix shape. Being particularly preferred, two groups of helix-shaped bars are provided, wherein the one group is spiralled around the longitudinal axis of the base body in a clockwise direction, while the other group is spiralled around the longitudinal axis in a counter-clockwise direction, wherein a bar of the one group respectively intersects with a bar of the other group at an end point of a rhombus-shaped opening. Being particularly preferred, a bar of the one helix-shaped type (spiralling in a clockwise direction) intersects a bar of the other helix -shaped type (spiralling in a counter-clockwise direction) only a single time or, in an alternative embodiment, only two times, or, in an alternative embodiment, only three times along its extension across the outer circumference of the retainer wall.

The invention additionally proposes a filter element. This filter element has a first support retainer, which is designed as a support retainer according to the invention. Furthermore, the filter element has a second retainer wall, which can also be designed as a support retainer according to the invention, but does not have to. Furthermore, the filter element has a filter material arranged between the first support retainer and a second support retainer. In a preferred embodiment, the filter element has an end cap at its upper end, which closes the space on the upper end formed between the first support retainer and the second support retainer. In addition or as an alternative, the filter element has an end cap on the upper end, which seals the space on the lower end formed between the first support retainer and the second support retainer. In a preferred embodiment, the end cap provided on the lower end is closed while an end cap provided on the upper end has an opening, which opens the interior space of the filter element toward the top.

In a preferred embodiment, the filter element features one or a plurality of the following materials: polyethersulfone (PES), polystyrene (PS), polypropylene (PP), polytetrafluoroethylene (PTFE), borosilicate, cellulose, cellulose acetate, polyvinylidene fluoride (PVDF), polyamide (PA) or polyphenylene sulphide (PPS).

In a preferred embodiment of the filter element according to the invention, the second support retainer extends along a coaxial longitudinal axis to the longitudinal axis of the first support retainer from an upper end of the second support retainer to a lower end of the support retainer, wherein a retainer wall is formed between the upper end and the lower end, which is designed to be ring-shaped perpendicular to the longitudinal axis at least in a cross section. Being particularly preferred in the case of such an embodiment, at least the outer support retainer is designed as a support retainer according to the invention.

In a preferred embodiment, the filter element according to the invention is used to filter fluids, being particularly preferred, to filter liquids. Being particularly preferred, the filter element according to the invention is used for sterile filtration, find filtration, pre-filtration and blank filtration.

The invention is explained in the following based on one of the drawings per training the exemplary embodiment of the invention. The single figure shows the support retainer according to the invention in a cross-sectional lateral view.

The support retainer 1 shown in FIG. 1 has a base body 2, which extends along a longitudinal axis A-A of an upper end to a lower end and which forms a retainer wall 3 between the upper end and the lower end. The retainer wall 3 is hollow cylindrical, and therefore perpendicular to the longitudinal axis A-A with a ring-shaped in each cross section. The retainer wall 3 has a plurality of rhombus-shaped openings 4.

All openings provided in the retainer wall 3 are rhombus-shaped. All rhombus openings 4 have the identical geometry (the same obtuse angles). The side lengths of all rhombus openings 4 are the same in length. All rhombus-shaped openings 4 are arranged in such a way that the extension of the rhombus-shaped openings 4 in the circumferential direction are greater than in a direction parallel to the longitudinal direction A-A of the base body 2.

As is particularly evident in the rhombus-shaped openings 4, which are shown in the cross section of FIG. 1, of the four lateral surfaces, which limit a rhombus-shaped opening, all opposite lateral surfaces 5, 6, 7, 8 are not orientated in parallel.

The rhombus-shaped openings 4 are arranged in such a way that the surface centre points M of the surfaces corresponding to the shape of the respective opening on the outer surface of the base body 2 (the surface centre points M of the perfusion surfaces of the rhombus-shaped openings 4 on the outer surface) are located on rings R1, R2, R3, the centre point of which lie on the longitudinal axis A-A of the base body. The arrangement of the surface centre points on a ring R1 are designed to be offset at a ratio to the arrangement of the surface centre points of the openings of an adjacent ring R2 in such a way that the openings of the one ring R1 engage into the space between the openings of an adjacent ring R2.

1. A support retainer for a filter element, the support retainer comprising:
a base body, which extends along a longitudinal axis from an upper end to a lower end and which forms a retainer wall between the upper end and the lower end,
wherein the retainer wall is ring-shaped at least in a cross-section perpendicular to the longitudinal axis, and
wherein the retainer wall has a plurality of openings, and
wherein the retainer wall is at least partially manufactured from a plastic, and
wherein the openings are rhombus-shaped.

2. The support retainer according to claim 1, wherein the rhombus-shaped openings extend in a circumferential direction to a greater extent than in a direction parallel to the longitudinal axis defined by the base body.

3. The support retainer according to claim 1, wherein an opening of the plurality of rhombus-shaped openings is limited by four lateral surfaces, of which two are opposite surfaces respectively, wherein at least two opposite lateral surfaces do not run parallel to one another.

4. The support retainer according to claim 1, wherein an opening of the plurality of rhombus-shaped openings is limited by four lateral surfaces, of which two are opposite surfaces respectively, wherein at least two opposite lateral surfaces run parallel to one another.

5. The support retainer according to claim 1, wherein the rhombus-shaped openings are arranged in such a way that surface centre points of the surfaces corresponding to the shape of the respective opening at the outer surface of the base body are on rings, wherein centre points of the rings are on the longitudinal axis defined by the base body.

6. The support retainer according to claim 1, wherein the rhombus-shaped openings form a consistent pattern with respect to their distribution across the base body.

7. The support retainer according to claim 1, wherein the retainer wall is at least partially manufactured from a polymer.

8. A filter element comprising:
a first support retainer according to claim 1;
a second support retainer, and
a filter material arranged between the first support retainer and the second support retainer.

9. The filter element according to claim 8, wherein the second support retainer extends along a coaxial longitudinal axis, coaxial to the longitudinal axis of the first support retainer, from an upper end to a lower end, and forms a retainer wall between the upper end and the lower end of the second support retainer, wherein the retainer wall of the second support retainer is designed to be perpendicular to the coaxial longitudinal axis and is ring-shaped at least in a cross section perpendicular to the coaxial longitudinal axis, and wherein the first support retainer is the outer support retainer.

10. A method comprising:
using the filter element according to claim 8 to filter fluids.
